(19) United States
(12) Patent Application Publication
(10) Pub. No.: US 2013/0248510 A1
(43) Pub. Date: Sep. 26, 2013

(54) ELECTRIC HEATER CAPABLE OF AUTOMATIC HEATING

(71) Applicants: Binggang Weng, Zhongshan (CN); Changsheng Liang, Zhongshan (CN)

(72) Inventors: Binggang Weng, Zhongshan (CN); Changsheng Liang, Zhongshan (CN)

(21) Appl. No.: 13/429,479

(22) Filed: Mar. 26, 2012

(51) Int. Cl. B23K 13/08

(52) U.S. Cl. 219/482

(57) ABSTRACT

An electric heater with automatic heating control includes a control apparatus box connected and integrated with an upper cover, a carbon tube, a control apparatus, a support, and a protection screen, with power switch on the top of the control apparatus box. A sensor-mounting hole is provided on the radial outside surface of the control apparatus box, and an infrared sensor is installed within the sensor-mounting hole. When used for heating, the power switch is On, and the carbon tube is powered on and starts heating while persons are within a certain range around the electric heater; the carbon tube is powered off and stops heating while persons leave from the electric heater and is out the detecting range of the infrared sensor, thereby the potential hazard to safety due to ignored power-off by person is eliminated, that is very convenient to user.

### FIELD

The present invention relates to a heating apparatus, and more particularly, to an electric heating heater.

### BACKGROUND

An electric heater is an apparatus capable of converting electric energy into heat energy. Nowadays it is widely used in residence, office, marketplace, hospital, school and so on. Compared to a traditional heating way, the electric heater is more convenient, more adoptable, more energy-saving and greener. Currently, the most common electric heaters on the market all need manual control. Generally, when people need to warm themselves, the electric heater is powered on to be operated, so heating goes on; and when people leave, they need to power off the electric heater always by themselves to make it stop. It is obvious that inconvenience still exits in using. Especially when a user leaves and forgets to power off the electric heater without being controlled by people, and it continues to work. As result, there are the potential hazard to safety and continues waste of electric energy.

Moreover, the common electric heaters on the market all are configured independently and used in houses. For those, it is hard to avoid discordance with the surrounding environment as well as the tables and chairs, that means they make the environment discordant, and make the feelings that more space is occupied.

### DISCLOSURE OF THE INVENTION

It is an object of the invention to provide an electric heater which can overcome the insufficiency of the related art; the electric heater is capable of automatic heating when people approach and stopping heating when people leave, which eliminates the potential hazard to safety. Furthermore, the electric heater also can be combined with the furniture to avoid the problem of space-occupying, and can be more accordant with the surrounding environment.

In order to solve the technical problems, the technical solution of the present invention is:

An electric heater capable of automatic heating includes:

a base;

a support, provided as a framework on the base;

a protection screen, fixed by the support and formed as a cylindrical shell, as well as a upper cover and a lower cover, positioned at the top and bottom of the protection screen to seal the cylindrical shell;

a carbon tube, located within the cylindrical shell formed by the protection screen as heating source;

a control apparatus box, located over the upper cover; and

a flat plate, located above the control apparatus box and supported by a connection stand; wherein

the outside surface of the control apparatus box is provided with a sensor-mounting hole, the sensor-mounting hole is installed with an infrared sensor, and is also provided with a transparent cover to seal the sensor-mounting hole; the control apparatus box is provided with a primary control PCB board to control the infrared sensor to send out infrared ray with code, and the primary control PCB board controls the carbon tube to work when the infrared sensor receives infrared ray reflected back by an obstacle, and controls the carbon tube to be powered off when the infrared sensor does not receive infrared ray.

As the further improvement of the above-mentioned aspect, a plurality of evenly distributed sensor-mounting holes are provided in the radial direction of the outside surface of the control apparatus box, each sensor-mounting hole is equipped with an infrared sensor and a transparent cover; the primary control PCB board controls the carbon tube to work according to an infrared ray signal detected by any one of the infrared sensor.

As the further improvement of the above-mentioned aspect, the top of the control apparatus box is provided with a LED light and a light switch.

A control switch of the above-mentioned primary control PCB board is provided on the top of the control apparatus box.

The center of the top of the control apparatus box protruded slightly, the LED light is provided at the protrusion, the switch and the control switch is provided on the control apparatus box in a manner of surrounding the LED light.

The LED light may perform the function of illumination, which is convenient for a user to turn on or off.

The mentioned flat plate may be a glass plate, and may combine with a table top plate; the adaptation of this structure combined with a base type structure of the electric heater may be used as a base of a table-type furniture, or the flat plate may be directly used as the table top, which achieves the combination between the electrical appliance and the furniture, and does not occupy extra indoor space.

As the further improvement of the above aspect, two supports are symmetrically provided along the diameter line of the base, and the two supports and the two semi-columnar protection screens are fixedly combined into the cylindrical shell.

The carbon tube is a cylindrical tubular shape, and is located at the central axis of the cylindrical shell. Thus, the carbon tube may radiates to the peripheral region of 360° when the carbon tube works, thereby reaching the effect of heating all round.

As the further improvement of the above aspect, a mirror reflection plate with an appropriate shape is provided on the inner side of the support toward the interior of the cylindrical shell, the mirror reflection plate may reflect ray of the carbon tube to avoid heat waste caused by the blockage of the carbon tube.

As the further improvement of the above aspect, a dummy plate is provided within the upper cover, two clip portions is provided respectively on symmetric sides of the dummy plate, and the two clip portions are respectively fastened to an upper fastening device of the two supports.

Wherein, the dummy plate may be a heat-insulating plate made of mica materials, which insulates heat of the carbon tube 51, to prevent an electrical element within the control apparatus box from being overheating.

The dummy plate may also be a heat-absorbing plate made of metal materials, and a temperature controller connected with the PCB board is provided at a position adjacent to the dummy plate to detect and control the temperature.

As the further improvement of the above aspect, an upper bracket is provided within the upper cover to fixedly install the top of the carbon tube, a lower bracket is provided within the lower cover to fixedly install the bottom of the carbon tube.

The upper bracket and the lower bracket are respectively provided with an upper spring and a lower spring for fastening the carbon tube as buffers.

The advantageous effects of the present invention: when the electric heater is powered on by the control switch for heating, the infrared sensors evenly installed in the control switch start working; when people are within a certain range around the electric heater, the carbon tube is powered on to perform heating; when people leave from the electric heater, and exceed the detecting range of the infrared sensor, the carbon tube is powered off to stop heating, thus the potential hazard to safety due to ignored power-off by people can be eliminated, that is very convenient in use. Furthermore, the flat plate located at the top may be used as the table top or be combined with the table top of the furniture, to make the electric heater be used as a column which is under the table top and supports the table top. Because the heater is hidden under the table top, it does not introduce any influence to the outside, and it is beneficial for the layout of the surrounding environment, and it does not occupy extra space. Also, in the form of positioned under the table top, the combination between the furniture and the electric appliance can be realized, and it is beneficial for heating when people sit around the table top. The electric heater may be designed as heating in one side or as heating in all outer peripheral sides, so as to meet different needs.

An electric heater with automatic heating control includes a base, a upper cover, a lower cover, a control apparatus box connected and integrated with the upper cover, a carbon tube, a control apparatus, a support, and a protection screen, in which a power switch of the control apparatus is provided on the top of the control apparatus box. It is characterized in that a sensor-mounting hole is provided on the radial outside surface of the control apparatus box, a infrared sensor is installed within the sensor-mounting hole, and a transparent cover seals the sensor-mounting hole. by using of this structure of the heater, when it is used for heating, the power switch is On, the infrared sensor starts working at that time, and the carbon tube is powered on and starts heating while persons are within a certain range around the electric heater; the carbon tube is powered off and stops heating while persons leave from the electric heater and is out the detecting range of the infrared sensor, thereby the potential hazard to safety due to ignored power-off by person is eliminated, that is very convenient to user.

### BRIEF DESCRIPTION OF DRAWINGS

The description is further made below in conjunction with the accompanying drawings as well as detailed embodiments:

FIG. 1 is a view for illustrating the structure of the present invention;

FIG. 2 is a view for illustrating the disassembly of the present invention;

FIG. 3 is a circuit diagram of the present invention; and

FIG. 4 is a circuit diagram of a primary control PCB board of the present invention.

### DESCRIPTION OF EMBODIMENTS

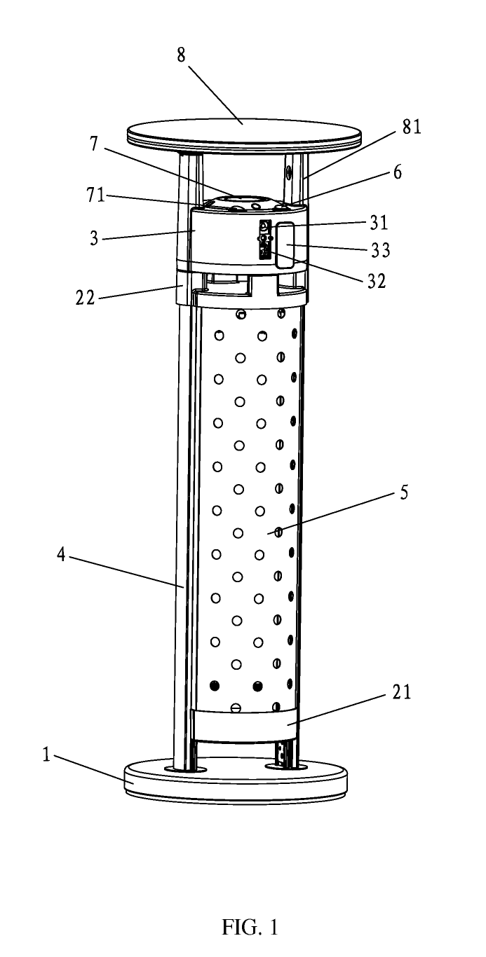

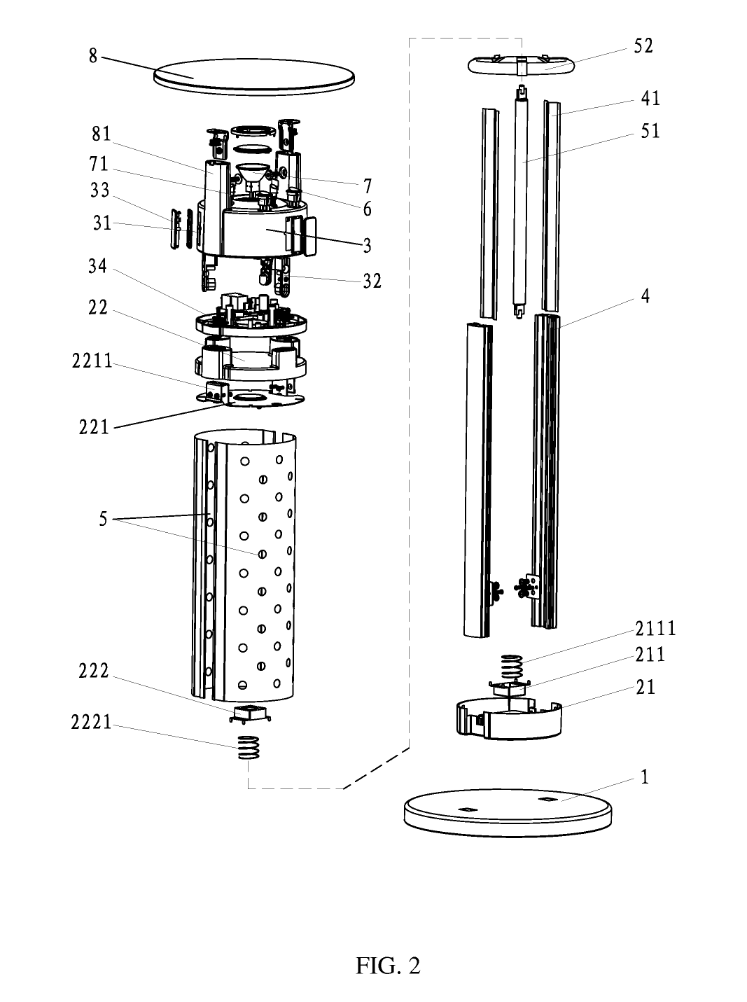

As illustrated in FIG. 1 and FIG. 2, an electric heater capable of automatic heating according to the present invention, includes basically in construction: a base 1; a support 4 is provided on the base 1 as a framework, which fixes a protection screen 5 to form a cylindrical shell; and a upper cover 22 and a lower cover 21 are provided respectively at the top and the bottom of the protection screen 5 to seal the cylindrical shell; a carbon tube 51 is provided within the cylindrical shell as heat source, and produces heat while working and radiates the heat to the outside of the protection screen 5 to archive the effect of heating; a control apparatus box 3 is provided over the upper cover 22 as a container of electronic elements; in addition, a flat plate 8 is provided at an adjacent position over the control apparatus box 3, supported by a connection stand 81, and may be designed as a glass plate to be directly used as a table top, or used as a mounting plate for integrating with and fastening to a position under a furniture platform so as to make the integral structure of the electric heater being a supporting column, realize the combination of the electric heater and the surrounding environment and furniture, and avoid more space occupied.

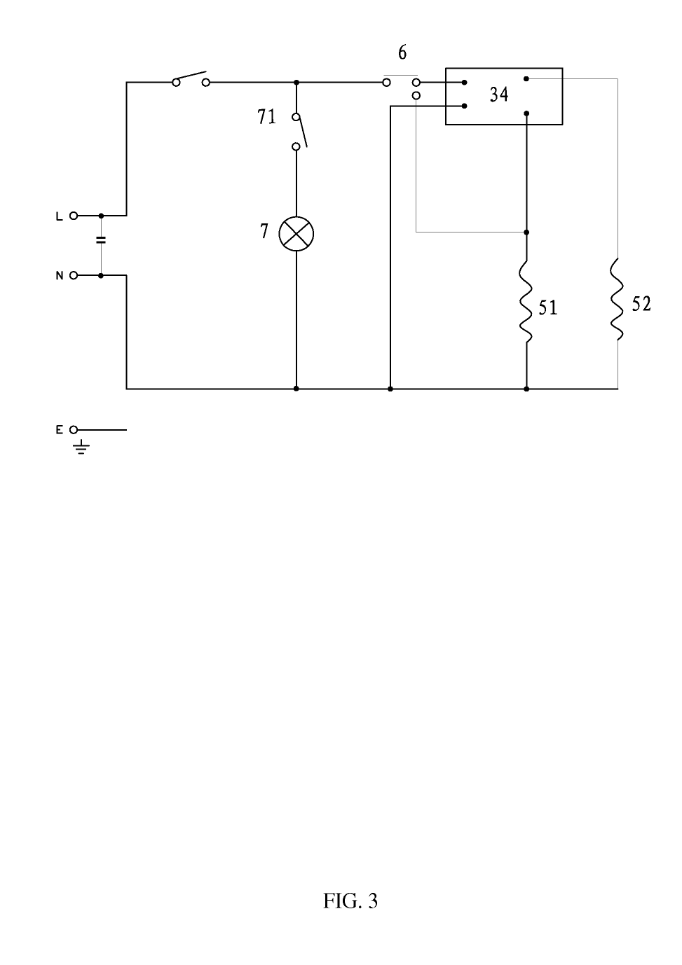

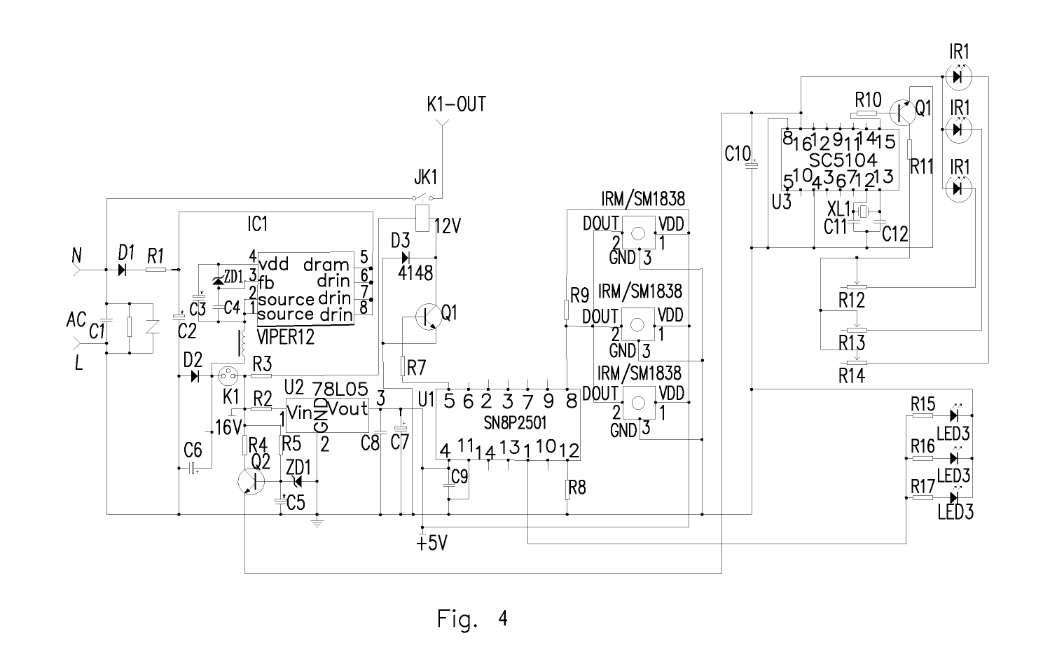

Thereinto, the outer surface of the control apparatus box 3 is provided with a sensor-mounting hole 31, in which an infrared sensor 32 is installed, and a Transparent cover 33 is provided to seals the sensor-mounting hole. Moreover, a primary control PCB board 34 is provided within the control apparatus box 3, as illustrated in FIG. 3 and FIG. 4, the primary control PCB board 34 is connected to power input, the infrared sensor 32 and the carbon tube 51, so as to control the carbon tube 51. The detailed control method is as following: when powered on, the infrared sensor 32 sends infrared ray with specific code to the peripheral region of the heater through the sensor-mounting hole 31 and the transparent cover 33, and detects in an effective reflection range whether there is an obstacle that reflects back the infrared ray with specific code; if the infrared sensor 32 does not receive any reflected signal, the primary control PCB board 34 controls the carbon tube 51 to be in the off-state; if infrared ray with corresponding code is reflected back, it is determined that there is an obstacle within the effective range; especially for the heater configured and set under the table top, there will be infrared ray that is reflected back to the infrared-sensor 32 when people approach the table top, thus the primary control PCB board 34 controls the carbon tube 51 to start work according to the reflected signals that are received, and radiate heat to peripheral so as to reach the effect of heating. After the electric heater of the present invention is once powered on, a user does not need to control it any more, thus the potential hazard to safety due to Ignored power-off by the user is avoided; and for the heater configured and set under the table top, when the user approaches the table top, for example, sitting by the table top, the heater starts heating, and when the user leaves from the table top, it stops heating, that is very convenient to the user. Moreover, by adopting infrared ray with specific code, the incorrect determination by the infrared sensor 32 caused by infrared ray sent from the carbon tube 51 itself and other infrared ray sources.

In other embodiments, according to the need, the electric heater may be designed and configured to detect and radiate heat in one side or multi-sides, or to radiate heat in all peripheral sides. As a preferred embodiment, heating in all peripheral sides (i.e. 360°) may better reflect the features of the present invention, wherein, as for detecting and sensing section, a plurality of evenly distributed sensor-mounting holes 31 is provided on the outside surface of the control apparatus box 3 in the radial direction, and each sensor-mounting hole 31 is equipped with an infrared sensor 32 and a transparent cover to allow infrared ray to fully cover the all peripheral sides. And the primary control PCB board 34 controls the carbon tube 51 to work according to the infrared signal detected by any one of the infrared sensors 32. As for the heating section, two supports 4 are symmetrically provided on the base 1 along the diameter line, and are fixedly combined with two semi-columnar protection screen 5 as a cylindrical shell; the carbon tube 51 is in a cylindrical tubular shape, and is located at the central axis of the cylindrical shell, so as to radiates heat to the periphery while working; and the heat passes through the protection screen 5 to cover the periphery; and because the heat may be impeded at the support 4, a mirror reflection board 41 in an appropriate shape is provided on the inner side of the support 4 and towards the inner space of the cylindrical shell, and reflects heat sent by the carbon tube 51, and radiates it out through the nearby protection screen 5, in order to avoid the waste of energy.

As for the way of powering on the carbon tube 51, a upper bracket 222 may be provided within the upper cover 22 to fixedly install together with the top of the carbon tube 51, a lower bracket 211 is provided within the lower cover 21 to fixedly install together with the bottom of the carbon tube 51. The electrical connection is performed through the upper bracket 222 and the lower bracket 211, connecting wires may be provided along the support 4 and hidden therein to perform the electric connection. In order to further protect the carbon tube 51 from damage while moving and carrying the electric heater, an upper spring 2221 and a lower spring 2111 for fastening the carbon tube 51 may be provided respectively at the upper bracket 222 and the lower bracket 211 to act as buffers.

Furthermore, in order to further protect an electrical elements and fixed connections between various components within the control apparatus box 3, a dummy plate 221 may be provided within the upper cover 22, and is provided with two clip portions 2211 respectively on a symmetric sides of the dummy plate 221, which are respectively fastened to two upper portions of the two supports 4 by means of clip device or by means of a screw. The dummy plate 221 may be configured variously according to the power level of the carbon tube 51. For example, in order to keep the heat within a certain range, the dummy plate 221 may be configured as an heat-absorbing plate made of metal materials, and provided with a temperature controller 35 connected with the PCB board 34 at a position adjacent to the dummy plate 221 to detect and control the temperature, so as to avoid overheating. For another example, if higher temperature and more heating is needed, the dummy plate 221 may be configured as an heat-insulating plate made of mica materials, to insulate heat from the carbon tube 51 during working, i.e. to prevent the heat from being transmitted to the control apparatus box 3. (It has been clearly noted that what is mentioned above is an alternative scheme, and there are many options, and they may be different according to the actual application environment, and preferably they are not limited in special way especially for the USA, Germany, to not limit the scope of patents).

Moreover, an LED light 7 and a light switch 71 may be provided on the top of the control apparatus box 3 for lighting and indicating, as well as increasing the sense of beauty. Meanwhile, a control switch 6 of the primary control PCB board 34 may be provided on the top of the control apparatus box 3. As a preferred scheme, the center of the top of the control apparatus box 3 may be slightly Protruded, the LED light 7 may be provided at the protrusion, and the light switch 71 and the control switch 6 are provided on the control apparatus box 3 in a manner of surrounding the LED light 7.

1. An electric heater capable of automatic heating, characterized in that said heater including:
a base (1);
a support (4), provided on the base (1) as a framework;
a protection screen (5), fixed by the support (4) to form a cylindrical shell, and
an upper cover (22) and a lower cover (21), located at the top and the bottom of the protection screen (5) to seal the cylindrical shell;
a carbon tube (51), located within the cylindrical shell formed by the protection screen (5) and used as heating source;
a control apparatus box (3), located above the upper cover (22); and
a flat plate (8), located above the control apparatus box (3) and supported by a connection stand (81); wherein
a sensor-mounting hole (31) is provided on the outside surface of the control apparatus box (3), an infrared sensor (32) is installed in the sensor-mounting hole (31), and a transparent cover (33) is provided to seal the sensor-mounting hole; a primary control PCB board (34) is provided in the control apparatus box (3), which controls the infrared sensor (32) to send out infrared ray with code, and controls the carbon tube (51) to work when the infrared sensor (32) receives infrared ray reflected back by an obstacle, and controls the carbon tube (51) to be powered off when the infrared sensor (32) does not receive infrared ray.

2. The electric heater capable of automatic heating according to claim 1, characterized in that a plurality of evenly distributed sensor-mounting holes (31) are provided on the outside surface of the control apparatus box (3) in the radial directions, each sensor-mounting hole (31) is equipped with an infrared sensor (32) and a transparent cover (33); the primary control PCB board (34) controls the carbon tube (51) to work according to an infrared ray signal detected by any one of the infrared sensors (32).

3. The electric heater capable of automatic heating according to claim 1, characterized in that the top of the control apparatus box (3) is provided with a LED light (7) and a light switch (71).

4. The electric heater capable of automatic heating according to claim 1, characterized in that two supports (4) are symmetrically provided along the diameter line of the base (1), which are fixedly combined with two semi-columnar protection screen (5) as a cylindrical shell.

5. The electric heater capable of automatic heating according to claim 4, characterized in that the carbon tube (51) is in a cylindrical tubular shape, and is located at the central axis of the cylindrical shell.

6. The electric heater capable of automatic heating according to claim 4, characterized in that a dummy plate (221) is provided within the upper cover (22), two clip portions (2211) are provided respectively on two symmetric sides of the dummy plate (221), and the two clip portions (2211) are respectively fastened to upper portions of the two supports (4).

7. The electric heater capable of automatic heating according to claim 4, characterized in that the upper cover (22) is provided with a upper bracket (222) to fixedly installed the top of the carbon tube (51), and the lower cove (211) is provided with a lower bracket (211) to fixedly installed the bottom of the carbon tube (51).

8. The electric heater capable of automatic heating according to claim 7, characterized in that the upper bracket (222) and the lower bracket (221) are respectively provided with an upper spring (2221) and a lower spring (2111) for fastening the carbon tube (51).

9. The electric heater capable of automatic heating according to claim 4, characterized in that a mirror reflection plate (41) with an appropriate shape is provided on the inner side of the support (4) toward the interior of the cylindrical shell.

10. The electric heater capable of automatic heating according to claim 6, characterized in that the dummy plate (221) may be an insulating plate made of mica materials.

11. The electric heater capable of automatic heating according to claim 6, characterized in that the dummy plate (221) may be an heat-absorbing plate made of metal materials; in a position adjacent to the dummy plate (221), a temperature controller (35) connected with the PCB board (34) is provided.

12. The electric heater capable of automatic heating according to claim 3, characterized in that the control switch (6) of the primary control PCB board (34) is provided on the top of the control apparatus box (3).

13. The electric heater capable of automatic heating according to claim 12, characterized in that the center of the top of the control apparatus box (3) is protruded slightly, the LED light (7) is provided at the protrusion, and the light switch (71) and the control switch (6) are provided on the control apparatus box (3) in a manner of surrounding the LED light (7).

14. The electric heater capable of automatic heating according to claim 1, characterized in that the flat plate (8) may be a glass plate, and may be merged with a table top plate.
